(19) United States
(12) Patent Application Publication
(10) Pub. No.: US 2010/0259492 A1
(43) Pub. Date: Oct. 14, 2010

(54) TOUCH PANEL DISPLAY WITH INFRARED LIGHT SOURCE

(75) Inventor: Tsung-Heng CHANG, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/609,138

(22) Filed: Oct. 30, 2009

(30) Foreign Application Priority Data
Apr. 8, 2009 (CN) 200910301415.1

(51) Int. Cl. G06F 3/041

(52) U.S. Cl. 345/173

(57) ABSTRACT

An exemplary touch panel display includes a display panel, a backlight module, an infrared camera, and a processor. The display panel has a touch surface. The backlight module includes a light guide plate and a light source module. The light source module includes a first light source and a second light source. The first light source is a visible light source, and the second light source is an infrared light source. Light emitted from the light guide plate transmits through the display panel. The infrared camera is disposed above the touch surface. The infrared camera is to detect infrared images corresponding to infrared light that emits from the light emitting surface of the light guide plate. The infrared camera detects the infrared image correspondingly. The processor is to receive the infrared image from the infrared camera and calculate a coordinate location of the object relative to the touch surface accordingly.

### BACKGROUND

1. Technical Field

The present disclosure relates to touch panel displays and, particularly, to a touch panel display having an infrared (IR) light source.

2. Description of Related Art

A touch panel that is integrally incorporated into a thin film transistor (TFT) liquid crystal display (LCD) has been proposed. A typical TFT LCD includes a pair of glass substrates which are separated by a layer of liquid crystal material. There are many types of touch panels, such as resistive touch panels, surface acoustic wave touch panels, capacitive touch panels, and infrared touch panels.

A typical infrared touch panel display includes an array of light sensors arranged along two sides of a rectangular display panel, and a corresponding array of IR light sources, such as LEDs, arranged along the other two sides of the display panel. When a user's finger or a stylus contacts the screen of the display panel, the IR light at the position of contact is blocked off, and thus the corresponding light sensors cannot detect all the IR light that emits from the LEDs. However, such arrangement requires a dense distribution of light sensors and LEDs, so it may not be cost effective. In addition, the arrays of LEDs and light sensors have to be configured differently to match different sized screens. This makes manufacturing of different sized display panels quite costly.

Therefore, a touch panel display which can overcome the above mentioned problems is desired.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the views.

FIG. 1 is a cross-sectional view of a touch panel display according to a first embodiment of the present invention.

FIG. 2 is a top plan view of a backlight module, infrared cameras, and a light source module of the touch panel display of FIG. 1.

FIG. 3 is a cross-sectional view of a touch panel display according to a second embodiment of the present disclosure.

FIG. 4 is a top plan view of a backlight module, an infrared camera, and a light source module of the touch panel display of FIG. 3.

### DETAILED DESCRIPTION

Various embodiments will now be described in detail below with reference to the drawings.

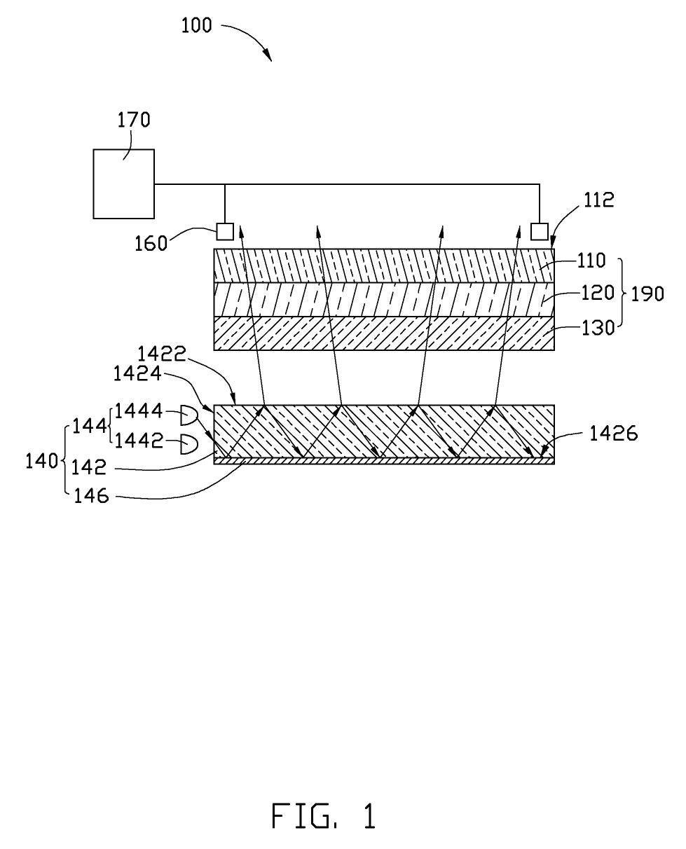

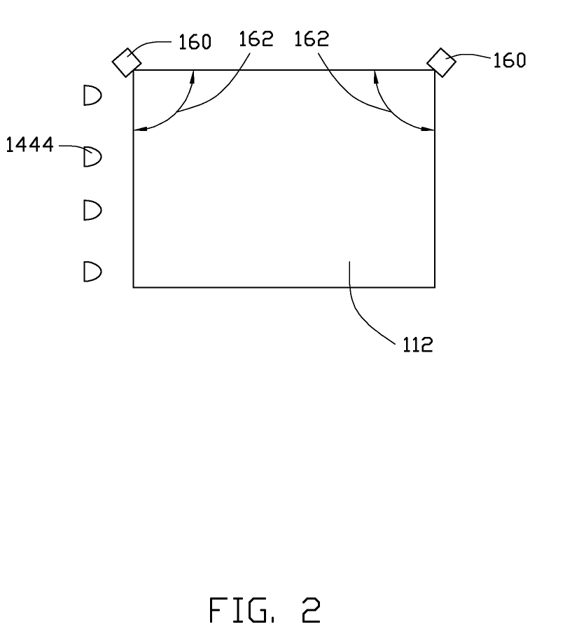

Referring to FIGS. 1-2, a touch panel display 100 according to a first embodiment is shown. The touch panel display 100 includes a display panel 190, a backlight module 140, two infrared cameras 160, and a processor 170. In the present embodiment, the display panel 190 is an LCD panel. The display panel 190 can be, for example, a reflective LCD, a transmissive LCD, or a transreflective LCD. In the present embodiment, the display panel 190 has a wide viewing angle. The viewing angle of the display panel 190 is in a range from about 170 to about 179 degrees.

The display panel 190 includes a first light pervious plate 110, a second light pervious plate 130, and a layer of liquid crystal material 120 arranged between the first light pervious plate 110 and the second light pervious plate 130. The first light pervious plate 110 includes a touch surface 112. In the present embodiment, the touch surface 112 is rectangular.

The backlight module 140 includes a light guide plate 142, a light source module 144, and a reflective sheet 146 on the bottom of the light guide plate 142.

The light guide plate 142 includes a top light emitting surface 1422 facing the second light pervious plate 130, a side surface 1424 adjacent the light emitting surface 1422, and a bottom surface 1426. The bottom surface 1426 can have a plurality of pattern dots (not shown) defined thereon.

In the present embodiment, the light source module 144 includes four first light sources 1442 and four second light sources 1444. Each of the first light sources 1442 is a visible-light LED for emitting visible light. Each of the second light sources 1444 is an infrared light source for emitting infrared light. It can be understood that the second light sources 1444 can be, for example, infrared LEDs or infrared lasers.

In the present embodiment, the four first light sources 1442 are arranged in a line parallel with the side surface 1424, and the four second light sources 1444 are arranged in a line parallel with the side surface 1424. The four second light sources 1444 are closer to the display panel 190 than the four first light sources 1442. In other embodiments, the first light sources 1442 and the second light sources 1444 can be arranged otherwise, as long as the light emitted from the light source module 144 includes visible light and infrared light. It can be understood that the numbers of first light sources 1442 and second light sources 1444 are not limited to the present embodiment.

Light emitted from the light source module 144 enters the light guide plate 142 through the side surface 1424, exits from the light emitting surface 1422, and then transmits through the second light pervious plate 130, the layer of liquid crystal material 120, and the first light pervious plate 110 in that order. Since the infrared light emitted from the second light sources 1444 is in the infrared portion of the light spectrum, it does not conflict with any image displayed in the visible portion of the light spectrum on the display panel 190.

Two infrared cameras 160 are disposed above the touch surface 112. In the present embodiment, the two infrared cameras 160 are located above two corners of the touch surface 112, such as at the upper left corner and at the upper right corner (as viewed in FIG. 2). The infrared cameras 160 should not be located at diagonally opposite corners of the touch surface 112, unless more than two infrared cameras 160 are used. Each infrared camera 160 includes a linear charge coupled device (CCD) sensor or a linear complementary metal oxide semiconductor (CMOS) transistor sensor. That is, taking the linear CCD sensor as an example, a photodiode array (the photoactive region) of the linear CCD sensor is arranged in a one-dimensional array.

In the present embodiment, each of the two infrared cameras 160 has a field of view 162, which is in a range from about 90 to about 120 degrees. Thus the entire touch surface 112 is covered by the overlapping fields of view 162 of the two cameras 160. The distance between each of the two infrared cameras 160 and the touch surface 112 depends on the viewing angle of the display panel 190. The larger the viewing angle of the display panel 190, the shorter the distance between each infrared camera 160 and the touch surface 112. Each infrared camera 160 can be considered to be capable of capturing an infrared image representing a single (horizontal) slice of the infrared light that emits from the top of the touch surface 112. It will be understood that the number of infrared cameras 160 can be more than two, depending on the size of the touch surface 112 and the field of view 162 of each infrared camera 160. The processor 170 is electrically connected to the two infrared cameras 160.

When no object is in contact with or adjacent the touch surface 112 of the first light pervious plate 110, a normal amount of infrared radiation emitting from the display panel 190 is detected by the two infrared cameras 160. That is, the infrared cameras 160 detect original images corresponding to the whole touch surface 112. Such detected original images are stored and usable as reference images. When an object (not shown), for example a user's finger or a stylus, touches or is adjacent the touch surface 112, some infrared radiation emitting from the display panel 190 is blocked by the object. Thus each infrared camera 160 does not detect the normal amount of infrared radiation that is ordinarily present along a horizontal light path that crosses the position of the object. That is, the infrared cameras 160 detect altered images corresponding to the whole touch surface 112. In one embodiment, calculating the angle of the object's position with respect to a center axis of the field of view 162 of each camera 160 can provide the information needed to identify the exact location of the object on or at the touch surface 112. The processor 170 processes the information received from the infrared cameras 160 to obtain the X, Y Cartesian coordinate location of the object relative to the first light pervious plate 110, i.e., the location of the “touch point.” The general principles relating to, inter alia, the capturing of infrared images by linear CCD sensors can be found in sources such as U.S. Pat. No. 4,507,557, the contents of which are incorporated herein by reference. The general principles relating to, inter alia, angular calculations for the purposes of identifying the exact location of a touching object can be found in sources such as U.S. Pat. No. 7,355,594, the contents of which are incorporated herein by reference.

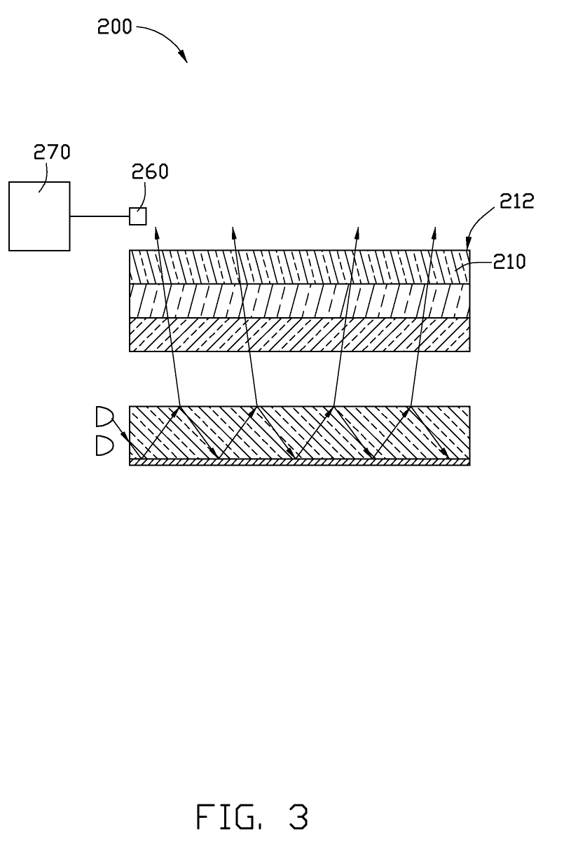

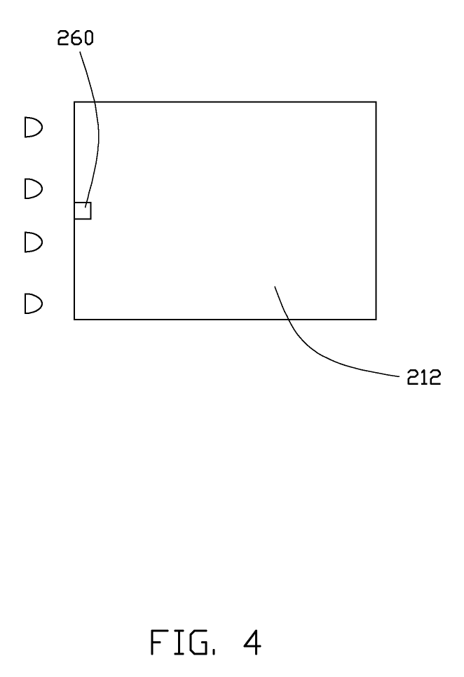

Referring to FIGS. 3-4, a touch panel display 200 according to a second embodiment is shown. The touch panel display 200 is similar to the touch panel display 100. However, there is only a single infrared camera 260, which includes a matrix CCD sensor or a matrix CMOS sensor. That is, taking the matrix CCD sensor as an example, a photodiode array (the photoactive region) of the matrix CCD sensor is arranged in a two-dimensional array. The infrared camera 260 can be considered to be capable of capturing a two-dimensional infrared image representing the infrared light that emits from the top of the touch surface 212. In the present embodiment, the infrared camera 260 is positioned a short distance above the touch surface 212. In the illustrated embodiment, the infrared camera 260 is above an edge portion of the touch surface 212, for example, halfway between two corners of the touch surface 212.

When no object is in contact with or adjacent the touch surface 212 of the first light pervious plate 210, a normal amount and pattern of infrared radiation emitting from the whole touch surface 212 of the display panel 290 is detected by the infrared camera 260. That is, the infrared camera 260 detects an original image of the whole touch surface 212. Such detected original image is then stored and usable as a reference image. When an object (not shown), for example a user's finger or a stylus, touches or is adjacent the touch surface 212, some infrared light emitting from the display panel 290 is blocked by the object. Therefore the infrared camera 260 detects an altered image of the touch surface 112; wherein the altered image typically includes a dark spot. The processor 270 compares the altered image to the reference image, calculates and obtains the X, Y Cartesian coordinate location of the object relative to the first light pervious plate 210. That is, the location of the “touch point” is obtained.

It can be understood that in alternative embodiments, there can be two or more infrared cameras 260. For example, when two infrared cameras 260 are employed, the sum of two separate fields of view of the two infrared cameras 260 can cover the entire touch surface 212.

In summary, the power consumption of the touch panel displays 100, 200 is low. In addition, the infrared cameras 160, 260 are easily positioned at various desired locations relative to the display panels, and the second light sources are easily positioned relative to the light guide plate. This means the same infrared cameras 160, 260 and the same second light sources 1444 can be readily adapted to a variety of the touch panel displays 100, 200 having different screen sizes.

While certain embodiments have been described and exemplified above, various other embodiments from the foregoing disclosure will be apparent to those skilled in the art. The present disclosure is not limited to the particular embodiments described and exemplified but is capable of considerable variation and modification without departure from the scope and spirit of the appended claims.

1. A touch panel display comprising:
a display panel having a touch surface;
a backlight module comprising a light guide plate and a light source module, the light guide plate comprising a light emitting surface facing the display panel, the light source module comprising a first light source and a second light source, the first light source being configured for emitting visible light, the second light source being configured for emitting infrared light, wherein light emitted from the light source module enters the light guide plate, emits from the light emitting surface of the light guide plate, transmits through the display panel, and exits from the touch surface;
at least one infrared camera disposed above the touch surface, the at least one infrared camera being configured for detecting infrared images corresponding to infrared light that emits from the touch surface, including detecting at least one infrared image when an object is in contact with or adjacent the touch surface; and
a processor configured for receiving the at least one infrared image from the infrared camera and calculating a coordinate location of the object relative to the touch surface accordingly.

2. The touch panel display of claim 1, wherein the coordinate location is a Cartesian coordinate location on the touch surface.

3. The touch panel display of claim 1, wherein the at least one infrared camera being configured for detecting infrared images further includes detecting at least one original image corresponding to the whole touch surface when no object is in contact with or adjacent the touch surface.

4. The touch panel display of claim 1, wherein the at least one infrared camera comprises one of a matrix charge coupled device (CCD) sensor and a matrix complementary metal oxide semiconductor (CMOS) transistor sensor.

5. The touch panel display of claim 4, wherein the at least one infrared camera is disposed above an edge portion of the touch surface.

6. The touch panel display of claim 1, wherein the at least one infrared camera comprises two infrared cameras, which are disposed above two corners of the touch surface.

7. The touch panel display of claim 6, wherein each of the two infrared cameras comprises one of a linear charge coupled device (CCD) sensor and a linear complementary metal oxide semiconductor (CMOS) transistor sensor.

8. The touch panel display of claim 6, wherein a viewing angle of the display panel is in a range from about 170 degrees to about 179 degrees.

9. The touch panel display of claim 8, wherein the fields of view of the two infrared cameras overlap each other and cooperatively cover the entire touch surface.

10. The touch panel display of claim 1, wherein the at least one infrared camera comprises two infrared cameras, and a field of view of each of the two infrared cameras is in a range from about 90 degrees to about 120 degrees.

11. The touch panel display of claim 1, wherein the light guide plate comprises a side surface, wherein the light emitted from the backlight module enters the light guide plate through the side surface.

12. A touch panel display comprising:
a display panel having a touch surface;
a backlight module comprising a light guide plate and a light source module, the light guide plate comprising a light emitting surface facing the display panel, the light source module comprising a first light source and a second light source, the first light source being configured for emitting visible light, the second light source being configured for emitting infrared light, wherein light emitted from the light source module enters the light guide plate, emits from the light emitting surface of the light guide plate, transmits through the display panel, and exits from the touch surface;
at least two infrared cameras disposed above the touch surface, each of the at least two infrared cameras comprising one of a linear charge coupled device (CCD) sensor and a linear complementary metal oxide semiconductor (CMOS) transistor sensor, the at least two infrared cameras being configured for detecting infrared images corresponding to infrared light that emits from the touch surface, including detecting infrared images when an object is in contact with or adjacent the touch surface; and
a processor configured for receiving the infrared images from the at least two infrared cameras and calculating a coordinate location of the object relative to the touch surface accordingly.

13. The touch panel display of claim 12, wherein fields of view of the two infrared cameras overlap each other and cooperatively cover the entire touch surface.

14. The touch panel display of claim 12, wherein the at least two infrared cameras are disposed above at least two corners of the touch surface.

15. A touch panel display comprising:
a display panel having a touch surface;
a backlight module comprising a light guide plate and a light source module, the light guide plate having a light emitting surface facing the display panel, the light source module comprising a first light source and a second light source, the first light source being configured for emitting visible light, the second light source being configured for emitting infrared light, wherein light emitted from the light source module enters the light guide plate, emits from the light emitting surface of the light guide plate, transmits through the display panel, and exits from the touch surface;
at least one infrared camera disposed above the touch surface, the at least one infrared camera comprising one of a matrix charge coupled device (CCD) sensor and a matrix complementary metal oxide semiconductor (CMOS) transistor sensor, the at least one infrared camera being configured for detecting infrared images corresponding to infrared light that emits from the touch surface, including detecting at least one infrared image when an object is in contact with or adjacent the touch surface; and
a processor configured for receiving the at least one infrared image from the infrared camera and calculating a coordinate location of the object relative to the touch surface accordingly.

16. The touch panel display of claim 15, wherein the coordinate location is a Cartesian coordinate location on the touch surface.

17. The touch panel display of claim 15, wherein the at least one infrared camera is disposed above an edge portion of the touch surface.
